(19) United States
(12) Patent Application Publication
(10) Pub. No.: US 2026/0276971 A1
(43) Pub. Date: Sep. 17, 2026

(54) DISTANCE-MEASURING AUTOFOCUS OBSERVATION INSTRUMENT

(71) Applicant: GUOFEI XIANG, Jiaxing (CN)

(72) Inventor: GUOFEI XIANG, Jiaxing (CN)

(21) Appl. No.: 19/080,449

(22) Filed: Mar. 14, 2025

(51) Int. Cl. G02B 23/06; G02B 7/06; G02B 7/09; G02B 23/18

(52) U.S. Cl. CPC G02B 23/06; G02B 7/06; G02B 7/09; G02B 23/18

(57) ABSTRACT

The present disclosure relates to the field of autofocus technology and discloses a distance-measuring autofocus observation instrument. The instrument comprises a distance-measuring circuit, a micro stepping motor, a control circuit, a photoelectric signal board, an assembly of eyepiece, prism and objective lens. Inside the main body of the observation instrument, the objective lens assembly, distance-measuring circuit, control circuit, and motor bracket are arranged. The surface of the objective lens assembly is provided with several limiting rings. The motor bracket is fixed with a micro stepping motor, and the output shaft of the micro stepping motor is fixed with a worm gear. Inside the motor bracket, there is a movable block, which has spiral teeth inside. One side of the movable block is provided with a connecting rod, which is fixed with a transmission insert plate. The purpose of the present disclosure is to provide a distance-measuring autofocus observation instrument.

### TECHNICAL FIELD

The present disclosure relates to the technical field of autofocus technology, specifically to a distance-measuring autofocus observation instrument.

### BACKGROUND

Focusing in an observation instrument refers to the adjustment of its optical system to ensure that light from distant celestial bodies forms a clear image on the focal plane. Proper focusing is crucial for successful observation, as it directly affects the instrument's resolution and image quality. In traditional observation instrument designs, a focusing knob structure is used to manually adjust the objective lens based on the clarity of the observed target as seen by the human eye. This manual rotation method has several drawbacks: focusing is achieved by manually adjusting the displacement of the objective lens. However, due to the user's unfamiliarity with the instrument, repeated trial adjustments near the focal point are often required, which prolongs the focusing process and reduces efficiency.

### SUMMARY

The purpose of the present disclosure is to provide a distance-measuring autofocus observation instrument that addresses the inefficiency caused by users'unfamiliarity with manual focusing, which leads to repeated adjustments, extended focusing time, and decreased focusing efficiency. To achieve the above objectives, the present disclosure adopts the following technical solution: a distance-measuring autofocus observation instrument, comprising a distance-measuring circuit, a micro stepping motor, a control circuit, a photoelectric signal board, an eyepiece assembly, a prism assembly, and an objective lens assembly, characterized in that the control circuit receives target distance information monitored by the distance-measuring circuit, converts this distance information into an objective lens displacement amount, and drives the micro stepping motor to adjust the objective lens assembly. The main body of the observation instrument contains the distance-measuring circuit and control circuit. The control circuit is electrically connected to both the micro stepping motor and the distance-measuring circuit. The objective lens assembly is positioned inside the instrument body, which has surface-positioning slots. Inside the instrument body, a combined bracket is installed, with a photoelectric signal board mounted at the upper part of the bracket, and a photoelectric sensor positioned above the board. A motor bracket is installed on the combined bracket, with a micro stepping motor fixed to one side of the motor bracket. The output shaft of the micro stepping motor is rotatably inserted into the motor bracket and is fixed with a worm gear at one end. A movable block is slidably positioned inside the motor bracket and includes a stop plate. The inner side of the movable block has helical teeth, which engage with the worm gear through a worm-wheel connection. One side of the movable block is connected to a connecting rod, with a transmission insert plate fixed at the other end of the rod. The surface of the objective lens assembly includes positioning rings and is provided with a guide slot, into which a positioning insert plate is inserted. The positioning insert plate is confined within the positioning slot on the lens body.

Preferably, the motor bracket contains a fixed sliding rod. One side of the connecting rod is equipped with a movable block insert plate, which is inserted and fixed into the movable block. Preferably, the instrument body has bracket screws that secure the combined bracket, with the micro stepping motor and photoelectric signal board fixed onto it. Preferably, the instrument body is equipped with fixing screws that press a guide pin, with the guide pin passing through and connecting to the connecting rod. Preferably, the interior of the observation instrument body contains a prism assembly, with an objective lens assembly positioned at the front end of the prism assembly and an eyepiece assembly also located at the front end. Preferably, the instrument includes two objective lens assemblies. One objective lens assembly is connected to a first bracket, while the other is connected to a second bracket. A third bracket connects the first and second brackets. A transmission block is attached to the bottom end of the first bracket, and the bottom end of the transmission block is engaged within the movable block.

Compared to existing technology, the distance-measuring autofocus observation instrument described in the present disclosure has the following advantages: in the focusing process, the observation instrument first utilizes its distance-measuring circuit to perform laser ranging on the target. The measured distance value is sent to the control circuit, which calculates the required objective lens displacement and controls the micro stepping motor accordingly. The activated micro stepping motor rotates its output shaft, driving the worm gear. The worm gear, through its helical connection with the movable block, enables the lateral movement of the movable block inside the motor bracket, which in turn synchronously moves the connecting rod. The connecting rod moves the objective lens assembly inside the instrument body, achieving automatic focusing. This reduces focusing time and increases efficiency. When the connecting rod is fixed inside the lens body, the guide pin passes through the rod and is secured by two fixing screws. As the micro stepping motor drives the movable block and connecting rod, the guide pin ensures precise linear movement. The guide slot and positioning insert plate further stabilize the movement of the objective lens assembly. This mechanism ensures the accurate transmission of motor displacement to the objective lens, achieving precise autofocus adjustments. As the movable block slides along the sliding rod, it drives the connecting rod, ensuring that the displacement of the stop plate matches the displacement of the objective lens during focusing. The stop plate passes through the photoelectric sensor, which provides real-time signal output for monitoring and positioning. Each movement of the stop plate through the sensor allows for precise tracking, ensuring high focusing accuracy.

### BRIEF DESCRIPTION OF DRAWINGS

FIG. 1 is a perspective schematic diagram of the embodiment.

FIG. 2 is a perspective schematic diagram of the assembly of the objective lens assembly and the micro stepping motor in the embodiment.

FIG. 3 is an exploded schematic diagram of the connection between the objective lens assembly and the connecting rod in the embodiment.

FIG. 4 is a perspective schematic diagram of the movable block in the embodiment.

FIG. 5 is a perspective schematic diagram of the photoelectric signal board, motor, and connecting rod in the embodiment.

FIG. 6 is a plan schematic diagram of the first bracket in the second embodiment.

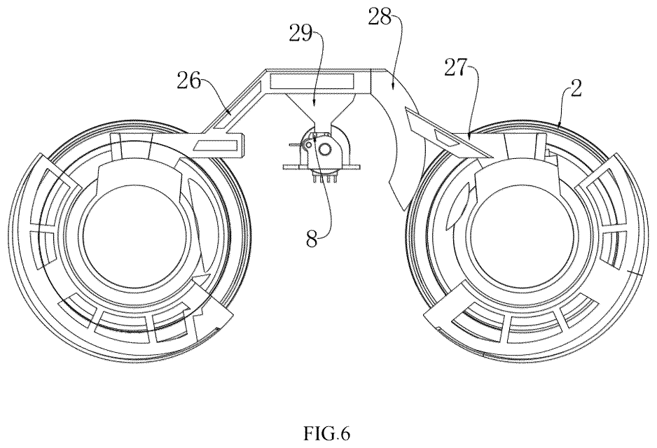

FIG. 7 is a system block diagram of the embodiment.

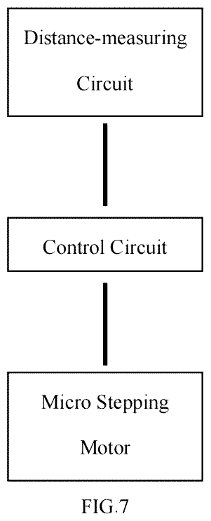

In the drawings: 1. Observation instrument body; 2. Objective lens assembly; 3. Distance-measuring circuit; 4. Control circuit; 5. Eyepiece assembly; 6. Prism assembly; 7. Micro stepping motor; 8. Combined bracket; 9. Photoelectric signal board; 10. Positioning slot; 11. Bracket screw; 12. Fixing screw; 13. Connecting rod; 14. Photoelectric sensor; 15. Movable block insert plate; 16. Guide pin; 17. Transmission insert plate; 18. Positioning insert plate; 19. Guide slot; 20. Movable block; 21. Sliding rod; 22. Worm gear; 23. Motor bracket; 24. Helical teeth; 25. Stop plate; 26. First bracket; 27. Second bracket; 28. Third bracket; 29. Transmission block; 30. Positioning ring.

### DESCRIPTION OF EMBODIMENTS

The following describes the preferred embodiments of the present disclosure in detail with reference to the accompanying drawings.

### EMBODIMENT 1

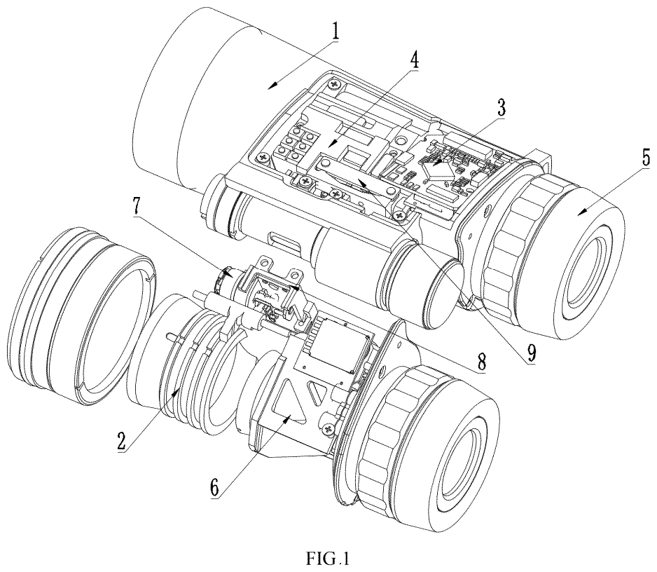

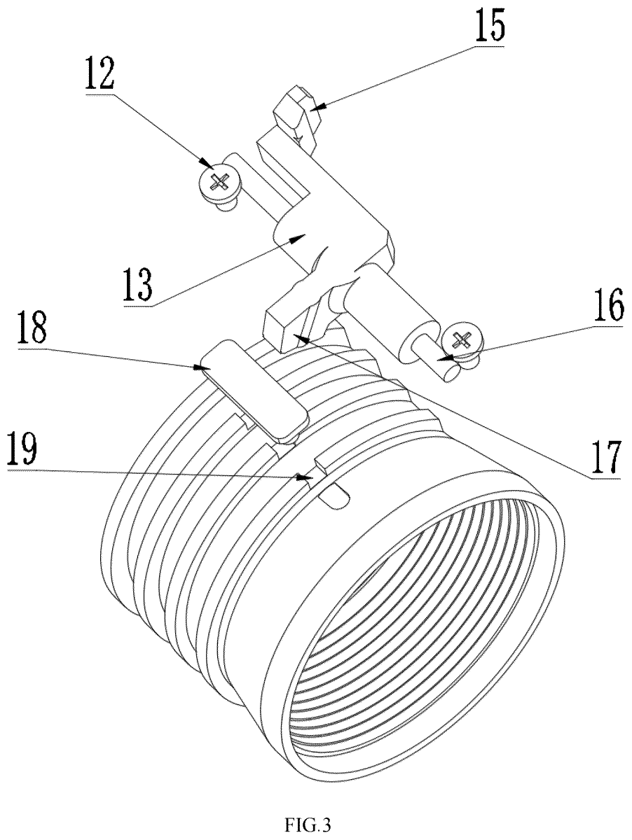

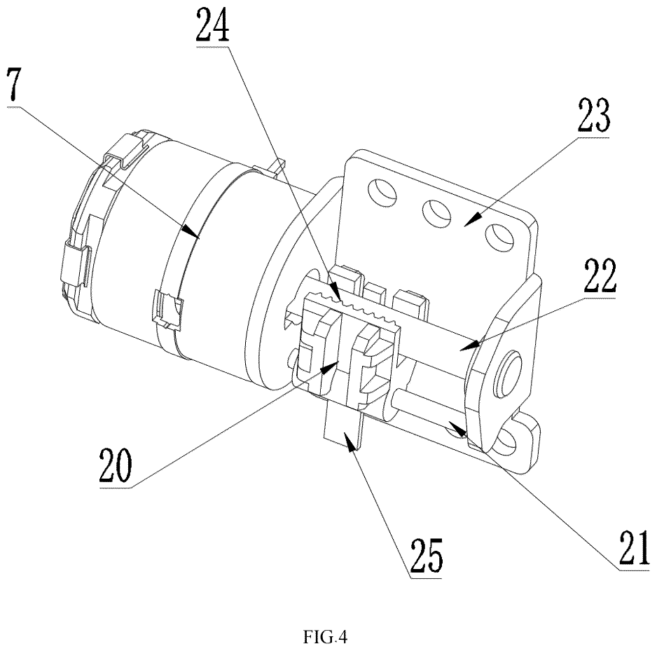

As shown in FIGS. 1-5, a distance-measuring autofocus observation instrument comprises a distance-measuring circuit 3, a micro stepping motor 7, a control circuit 4, a photoelectric signal board 9, an eyepiece assembly 5, a prism assembly 6, and an objective lens assembly 2. The control circuit 4 receives target distance information monitored by the distance-measuring circuit 3, converts this distance information into an objective lens displacement amount, and drives the micro stepping motor 7 to adjust the objective lens assembly 2. The control circuit 4 is electrically connected to both the micro stepping motor 7 and the distance-measuring circuit 3. The objective lens assembly 2 is installed in the observation instrument body 1 and positioned using the positioning insert plate 18, which is inserted into the positioning slot 10 and guide slot 19. The interior of the observation instrument body 1 is provided with a combined bracket 8, on which a motor bracket 23 is fixed. One side of the motor bracket 23 is fixed with a micro stepping motor 7, whose output shaft is rotatably inserted into the motor bracket 23 and fixed with a worm gear 22 at one end. A movable block 20 is slidably positioned inside the motor bracket 23, and its inner side has helical teeth 24 engaged with the worm gear 22 via a worm-wheel connection. One side of the movable block 20 is connected to a connecting rod 13, which is fixed at the other end to a transmission insert plate 17. The transmission insert plate 17 is inserted into the positioning ring 30 set on the surface of the objective lens assembly 2. The objective lens assembly 2 is further provided with a guide slot 19, where a positioning insert plate 18 is inserted and confined within the positioning slot 10 on the lens body.

During the focusing process, the distance-measuring circuit 3 first measures the target distance and sends the detected distance value to the control circuit 4. The control circuit 4 then calculates the required displacement of the objective lens and controls the micro stepping motor 7 to open or close accordingly. The activated micro stepping motor 7 rotates its output shaft, which drives the worm gear 22. As the worm gear 22 rotates, it engages with the helical teeth 24, driving the movable block 20 to move back and forth inside the motor bracket 23. The movement of the movable block 20 synchronously moves the connecting rod 13, which, through the transmission insert plate 17 inserted into the positioning ring 30, linearly moves the objective lens assembly 2 inside the observation instrument body 1. It should be noted that this focusing method can be applied to all types of observation instruments or equipment, such as telescopes, rangefinders, thermal imaging devices, night vision devices, and scopes, allowing the objective lens to move automatically for autofocus, thereby reducing focusing time and improving efficiency.

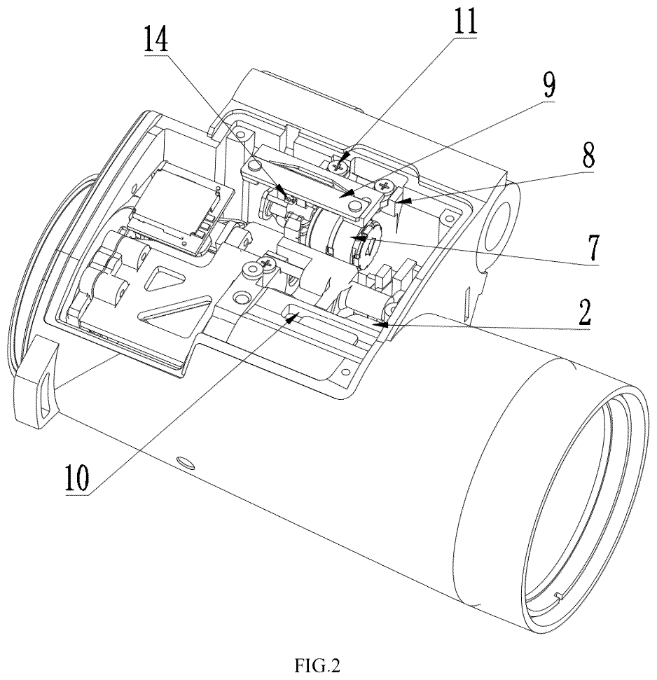

As shown in FIGS. 2-5, the interior of the observation instrument body 1 is provided with fixing screws 12, which press the guide pin 16 that passes through and connects to the connecting rod 13. The connecting rod 13 is also provided with a movable block insert plate 15, which is inserted into and fixed with the movable block 20.

During operation, when the movable block 20 drives the movable block insert plate 15, which in turn transmits movement to the connecting rod 13 along the guide pin 16, the transmission insert plate 17 of the connecting rod 13 is inserted into the positioning ring 30 of the objective lens assembly 2. This ensures that the displacement of the movable block 20, stop plate 25, and objective lens assembly 2 remain synchronized.

### EMBODIMENT 2

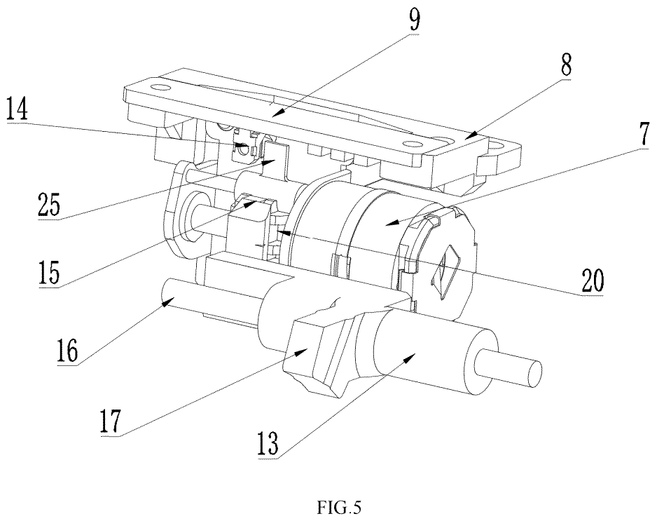

As shown in FIGS. 1 and 5, in this embodiment, two objective lens assemblies 2 are used. One objective lens assembly 2 is connected to a first bracket 26, while the other is connected to a second bracket 27. A third bracket 28 connects the first bracket 26 and the second bracket 27. The bottom end of the first bracket 26 is connected to a transmission block 29, whose bottom end is engaged within the movable block 8.

During operation, this configuration allows for simultaneous focusing of two objective lens assemblies 2, functioning similarly to Embodiment 1, as described below:

When the micro stepping motor 6 is activated, its output shaft drives the worm gear 7 to rotate. As the worm gear 7 rotates, it engages with the helical teeth 9 through a threaded connection, driving the movable block 8 to move laterally inside the motor bracket 5. During this lateral movement, the transmission block 29 moves synchronously, which in turn drives the first bracket 26, second bracket 27, and third bracket 28. This mechanism enables a single micro stepping motor 6 to simultaneously adjust the focus of two objective lens assemblies 2, thereby reducing operational complexity and improving focusing efficiency.

The above description provides the preferred embodiments of the present disclosure. However, the protection scope of the present disclosure is not limited to these examples. Any modifications or equivalent replacements made by those skilled in the art within the scope of the disclosed technology and concepts of the present disclosure should be covered within its protection scope.

What is claimed is:

1. A distance-measuring autofocus observation instrument, comprising a distance-measuring circuit, a micro stepping motor, a control circuit, a photoelectric signal board, an eyepiece assembly, a prism assembly, and an objective lens assembly, characterized in that: The control circuit receives target distance information monitored by the distance-measuring circuit, converts the distance information into an objective lens displacement amount, and drives the micro stepping motor to adjust the objective lens assembly. Inside the main body of the observation instrument, the distance-measuring circuit and control circuit are installed, with the control circuit electrically connected to both the micro stepping motor and the distance-measuring circuit. The objective lens assembly is located inside the main body. The surface of the observation instrument body is provided with positioning slots. Inside the instrument body, a combined bracket is arranged, with a photoelectric signal board mounted at the upper part of the combined bracket, and a photoelectric sensor positioned above the photoelectric signal board. The combined bracket is equipped with a motor bracket, with a micro stepping motor fixed to one side of the motor bracket. The output shaft of the micro stepping motor is rotatably inserted into the motor bracket and fixed with a worm gear at one end. A movable block is slidably arranged inside the motor bracket and is provided with a stop plate. The inner side of the movable block features helical teeth, which engage with the worm gear via a worm-wheel connection. One side of the movable block is equipped with a connecting rod, with a transmission insert plate fixed at the other end of the connecting rod. The surface of the objective lens assembly includes positioning rings and is provided with a guide slot, into which a positioning insert plate is inserted. The positioning insert plate is confined within the positioning slot on the lens body.

2. The distance-measuring autofocus observation instrument according to claim 1, characterized in that: A sliding rod is fixed inside the motor bracket, and a movable block insert plate is arranged on one side of the connecting rod. The movable block insert plate is inserted and fixed to the movable block.

3. The distance-measuring autofocus observation instrument according to claim 1, characterized in that: The observation instrument body is provided with bracket screws, which secure the combined bracket. The micro stepping motor and the photoelectric signal board are fixed onto the combined bracket.

4. The distance-measuring autofocus observation instrument according to claim 2, characterized in that: The observation instrument body is equipped with fixing screws that press a guide pin, with the guide pin passing through and connecting to the connecting rod.

5. The distance-measuring autofocus observation instrument according to claim 1, characterized in that: The interior of the observation instrument body contains a prism assembly, with an objective lens assembly positioned at the front end of the prism assembly, and an eyepiece assembly also arranged at the front end of the prism assembly.

6. The distance-measuring autofocus observation instrument according to claim 1, characterized in that: There are two objective lens assemblies. One objective lens assembly is connected to a first bracket, while the other is connected to a second bracket. A third bracket connects the first and second brackets. A transmission block is connected at the bottom end of the first bracket, and the bottom end of the transmission block is engaged within the movable block.
